(19) United States
(12) Patent Application Publication
(10) Pub. No.: US 2019/0312490 A1
(43) Pub. Date: Oct. 10, 2019

(54) FAULT-TOLERANT MOTOR

(71) Applicant: Seung Ho TAK, Seoul (KR)

(72) Inventor: Seung Ho TAK, Seoul (KR)

(21) Appl. No.: 16/335,270

(22) PCT Filed: Jul. 13, 2017
(86) PCT No.: PCT/KR2017/007534

§ 371 Date: Mar. 21, 2019

(30) Foreign Application Priority Data
Sep. 23, 2016 (KR) 10-2016-0122202

(51) Int. Cl. H02K 11/25; H02K 1/27; H02K 1/14; H02K 11/33; H02K 11/27; H02K 16/04

(52) U.S. Cl. CPC H02K 11/25; H02K 1/2706; H02K 16/04; H02K 11/33; H02K 11/27; H02K 1/14

(57) ABSTRACT

A fault-tolerant motor according to one embodiment of the present invention includes: a stator including an inner core stator and an outer core stator, which are formed in an annular shape and disposed opposite to each other with a gap therebetween, and a coreless stator disposed on at least one selected from the inner core stator and the outer core stator; and a rotor connected to a rotating shaft and rotated and including a core permanent magnet inserted into the gap and a coreless permanent magnet disposed on a surface facing the coreless stator.

### Technical Field

The present invention relates to a fault-tolerant motor, and more particularly, to a fault-tolerant motor having a triple stator.

### Background Art

Generally, brushless direct-current (BLDC) motors are classified according to the presence of a stator core, and are classified into a core-type having a cylindrical or disc structure and a coreless-type that does not have a stator and a core. The core-type BLDC motor has a structure in which a magnetic circuit is symmetrical with respect to a shaft in a radial direction, and thus, has less axial vibration noise and is suitable for a low-speed rotation. Further, the core-type BLDC motor has a very small portion occupied by an air gap in a magnetic path direction, and thus, has high magnetic flux density, high torque, and high efficiency even when a low-performance magnet is used.

The core-type BLDC motor is classified into an inner magnet type including a cylindrical stator in which coils are wound on a plurality of protrusions formed on an inner peripheral portion thereof to have an electromagnet structure and a rotor composed of a cylindrical permanent magnet, and an outer magnet type including a stator in which coils are wound on a plurality of projections formed on an outer peripheral portion thereof in a vertical direction and a rotor in which neodymium magnets or cylindrical permanent magnets that are multipolar magnetized are attached to the outside of the stator at regular intervals. The core-type BLDC motor is also classified into an outer-rotor type in which a rotor is located outside and an inner-rotor type in which a rotor is located inside.

### DISCLOSURE

### Technical Problem

The present invention is directed to providing a motor capable of rotating without stopping even when an error occurs in some driving circuits or stators in the rotation of the motor, and reducing the size and weight by preventing an increase in volume and weight to prevent overheating or overcurrent, thereby increasing energy efficiency.

### Technical Solution

One aspect of the present invention provides a fault-tolerant motor including: a stator including an inner core stator and an outer core stator, which are formed in an annular shape and disposed opposite to each other with a gap therebetween, and a coreless stator disposed on at least one selected from the inner core stator and the outer core stator; and a rotor connected to a rotating shaft and rotated and including a core permanent magnet inserted into the gap and a coreless permanent magnet disposed on a surface facing the coreless stator.

Each of the inner core stator and the outer core stator may include an annular body having a coupling groove, a divided core having a protrusion inserted into and coupled to the coupling groove, a bobbin surrounding the divided core, and an electric wire wound around the bobbin.

The fault-tolerant motor may further include a controller connected to the stator, and configured to apply current to all the stators to operate all the stators during an initial or emergency operation and select and operate sequentially at least one of the inner core stator, the outer core stator, and the coreless stator when torque or a rotation speed of the motor is in a normal track.

The controller may measure a temperature of each stator, and when the temperature is equal to or greater than a preset range, the controller may cut off the current flowing to the overheated stator and apply the current to the stator in a pause period to drive the motor without stopping.

When an abnormality occurs in any one of the stators, the controller may cause the stator in the pause period to replace a role of the stator in which the abnormality occurs to drive the motor without stopping.

Each stator may be connected to two or more driving circuits, and the controller may sequentially operate each of the two or more driving circuits.

The fault-tolerant motor may further include an overcurrent sensor connected to the driving circuit and configured to measure the current flowing to the driving circuit, or a temperature sensor connected to the driving circuit and configured to measure a temperature of the driving circuit

The controller may be composed of a master-slave dual controller, and the master-slave dual controller may record and transmit whether an overheating or overcurrent operation or a failure occurred in a driving process to support driving without stopping and maintenance.

### Advantageous Effects

A fault-tolerant motor according to an embodiment of the present invention can be operated without stopping by maintaining rotation even when a circuit or stator has a problem.

A motor can be implemented, which can prevent an accident such as a fall or a sudden stop in electric vehicles or drones by an operation without stopping the motor while improving a problem, in which a size (volume) of the electric vehicle or drone become increase and a weight of the electric vehicle or drone become heavier because the motor is designed to have an increased output in order to prevent the motor from malfunctioning during driving and causing a major accident, through an optimization design.

Further, when a motor is maintained based on drive history information of a fault-tolerant motor by recording error or event information such as overheating and overcurrent, which are generated during operation, and a switching cycle in memory, a specialized company for maintenance can determine when to replace an abnormal module so that costs can be reduced, and a user can own the fault-tolerant motor continuously and prevent an accident from occurring.

### DESCRIPTION OF DRAWINGS

FIG. 1 is a perspective view of a fault-tolerant motor according to one embodiment.

FIG. 2 is an exploded view of the fault-tolerant motor shown in FIG. 1.

FIG. 3 is a bottom view of a rotor shown in FIG. 2.

FIG. 4 is an exploded view of a stator shown in FIG. 2.

FIG. 5 is an exploded view of a core stator shown in FIG. 4.

FIG. 6 is a block diagram of the fault-tolerant motor according to one embodiment.

FIG. 7 is a view for describing a control sequence of a controller according to one embodiment.

FIG. 8 is a block diagram of a fault-tolerant motor according to another embodiment.

FIG. 9 is a view for describing a control sequence of a controller according to another embodiment.

### MODES OF THE INVENTION

Embodiments of the present invention will be fully described in detail which is suitable for easy implementation by those skilled in the art with reference to the accompanying drawings. However, the present invention may be implemented in various different forms and is not limited to the embodiments described herein.

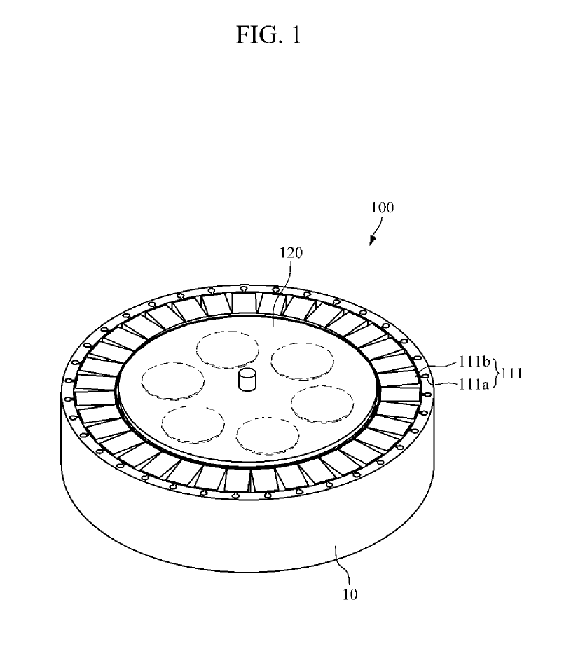

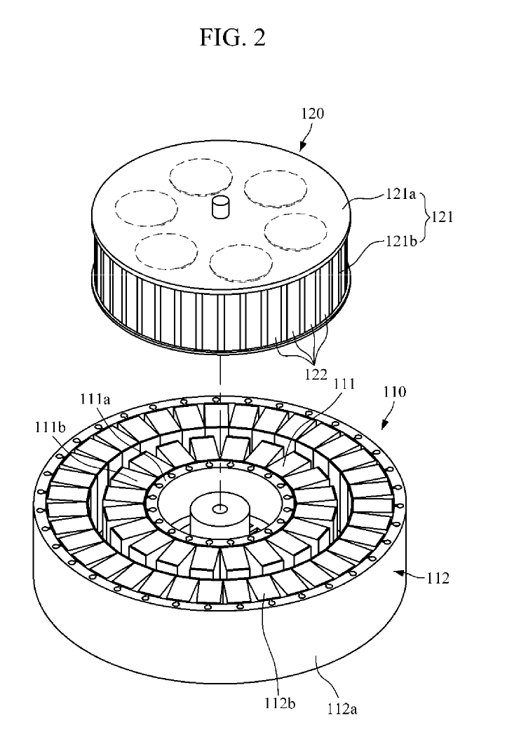

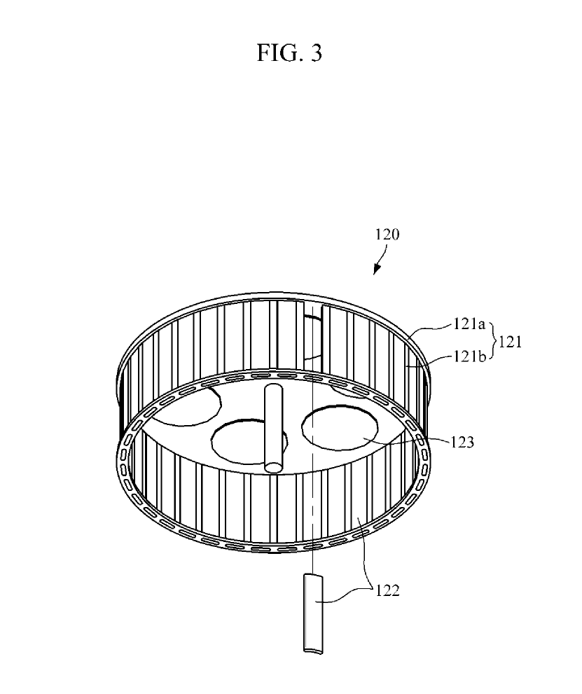

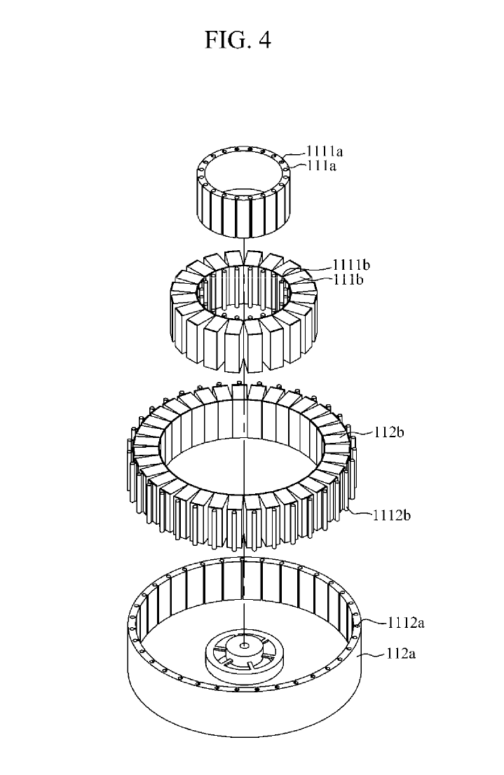

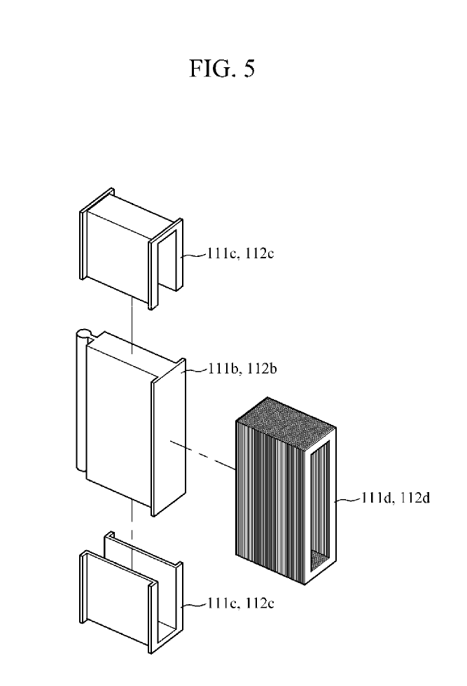

Hereinafter, a fault-tolerant motor 100 according to an embodiment of the present invention will be described in detail with reference to the drawings. FIG. 1 is a perspective view of a fault-tolerant motor according to one embodiment, FIG. 2 is an exploded view of the fault-tolerant motor shown in FIG. 1, FIG. 3 is a bottom view of a rotor shown in FIG. 2, FIG. 4 is an exploded view of a stator shown in FIG. 2, and FIG. 5 is an exploded view of a core stator shown in FIG. 4.

Referring to FIGS. 1 to 5, the fault-tolerant motor 100 according to the embodiment of the present invention may continuously rotate without stopping, and includes a stator 110, a rotor 120, and a controller 130. The stator 110 includes core stators 111 and 112 having a core, and a coreless stator 113 that does not include a core. In order to prevent generation of interference between the core stators 111 and 112 and the coreless stator 113, a ferrite sheet may be attached under the coreless stator 113. The core stators 111 and 112 include an inner core stator 111 and an outer core stator 112 which are disposed opposite to each other with a gap therebetween. As an example, the inner core stator 111 and the outer core stator 112 are formed in an annular shape.

Each of the inner core stator 111, the outer core stator 112, and the coreless stator 113 is connected to a driving circuit so that magnetic circuits are formed independently, thereby performing a triple stator function that may play a complementary role.

It is possible to implement the fault-tolerant motor 100 capable of applying current to both the core stators 111 and 112 and the coreless stator 113 to increase torque or speed as the magnetic circuits formed from the inner core stator 111 and the outer core stator 112 substantially act on a core permanent magnet 122, and the magnetic circuit formed from the coreless stator 113 substantially acts on a coreless permanent magnet 123; and applying the current only to one stator 110 to improve efficiency of an electromagnetic field and the current and simultaneously rotating without stopping as a magnetic field of each of the stators 111, 112, and 113 is magnetically shielded by a ferrite sheet so as not to affect the magnetic field of the adjacent stator, so that interference does not occur.

The core stator 110 may be formed in an assembly type so as to be assembled after being wound by a simple process to solve the difficulty of a coil winding process, and includes annular bodies 111a and 112a, divided cores 111b and 112b, bobbins 111c and 112c, and electric wires 111d and 112d. The annular body 112a of the outer core stator 112 includes coupling grooves 1112a formed on an inner peripheral surface thereof, and the annular body 111a of the inner core stator 111 includes coupling grooves 1111a formed on an outer peripheral surface thereof.

The divided cores 111b and 112b include protrusions 1111b and 1112b each having a shape corresponding to the respective coupling grooves 1111a and 1112a so as to be inserted into and coupled to the respective coupling grooves 1111a and 1112a of the core stator 110. Accordingly, in an assembling process, a process of winding the electric wires 111d and 112d on the divided cores 111b and 112b is preferentially performed, and then a process of coupling the divided cores 111b and 112b to the annular bodies 111a and 112a is sequentially performed. Thus, the simple process may be performed even when the core stator 110 having a small size is manufactured.

As an example, the divided cores 111b and 112b may be formed by press processing and then laminating a silicon steel plate, but the present invention is not limited thereto. The bobbins 111c and 112c are formed so as to surround the divided cores 111b and 112b. As an example, the bobbins 111c and 112c may be formed to surround the divided cores 111b and 112b in a state of being divided into two or more. However, as another example, the bobbins 111c and 112c may be formed as an integral type surrounding the divided cores 111b and 112b. Coils of the enamel coated electric wires 111d and 112d are wound on the bobbins 111c and 112c, and the current is applied thereto to rotate the rotor 120. The electric wires 111d and 112d may be wound by various shapes such as a U-shape, a V-shape, and a W-shape, and the like.

The inner core stator 111 is formed to be smaller than the outer core stator 112, and the outer core stator 112 is formed to surround the inner core stator 111 with a gap therebetween.

As an example, the divided core 111b of the inner core stator 111 and the divided core 112b of the outer core stator 112 may be disposed on a straight line.

As another example, the divided core 111b of the inner core stator 111 may be disposed alternately with the divided core 112b of the outer core stator 112, so that cogging torque noise of a brushless direct-current (BLDC) motor may be reduced. Here, the divided core 111b of the inner core stator 111 and the divided core 112b of the outer core stator 112 may partially overlap each other.

The coreless stator 113 is disposed on an upper portion of the core stator 110 and is formed only by coil winding without a core. As an example, the coreless stator 113 may be disposed on the inner core stator 111 as shown in FIG. 1. However, the present invention is not limited thereto, and the coreless stator 113 may also be disposed on the outer core stator 112, and on the inner core stator 111 and the outer core stator 112 to overlap each other. The coreless stator 113 applies an electromagnetic force substantially to the coreless permanent magnet 123.

The coreless stator 113 may have a shape wound in a circular shape as shown in FIG. 1, but the present invention is not limited thereto, and the coreless stator 113 may be wound in a polygonal shape such as an elliptical shape, a triangular shape, or a quadrangular shape, and the like.

The coreless stator 113 does not need a core, and thus, may be easily mounted in a narrow space, and applicability in various applications may be improved. Furthermore, electrical loss due to the core may be prevented, and vibration and noise phenomena affecting the rotor 120 may also be reduced.

The rotor 120 is axially connected to a rotating shaft (not shown), is rotated by an electromagnetic force of the stator 110 to which the current is applied, and includes a frame 121 of the rotor 120, the core permanent magnet 122 and the coreless permanent magnet 123. The frame 121 of the rotor 120 includes a base 121a covering the inner core stator 111 and an extension 121b bent and extended from the base 121a. The base 121a is formed so as to cover the entire coreless stator 113 and axially connected to the rotating shaft (not shown). The extension 121b is inserted into the gap between the inner core stator 111 and the outer core stator 112 and is also coupled to the coreless permanent magnet 123.

As an example, the base 121a may be formed of aluminum, and the extension 121b may be formed of stainless steel that is a material not affected by magnetism, but the present invention is not limited thereto. Further, the base 121a and the extension 121b may be formed in an assembly type, but the inventive concept is not limited thereto, and the base 121a and extension 121b may be formed in an integral type.

The core permanent magnet 122 is coupled to the extension 121b, which is disposed in the gap having curvatures at both ends thereof between the outer core stator 112 and the inner core stator 111. In the core permanent magnet 122, N-pole and S-pole magnets having curvatures on both side surfaces thereof may be alternately disposed in multiple numbers. The curvatures formed at both ends of the core permanent magnet 122 may prevent the magnet from being separated during high-speed rotation. The core permanent magnet 122 is attachable to and detachable from the extension 121b.

The core permanent magnet 122 is substantially interlocked with an electromagnetic force of the outer core stator 112 and an electromagnetic force of the inner core stator 111.

The core permanent magnet 122 generates repulsion to the core stator 110 having the same polarity and generates attraction to the core stator 110 having a different polarity among the stator 110 that generates a magnetic force field. As an example, when the core permanent magnet 122 has the same magnetic pole as that of the outer core stator 112, the core permanent magnet 122 generates repulsion to the outer core stator 112 and generates attraction to the inner core stator 111. However, this is only an example, and the polarities of the outer core stator 112 and the inner core stator 111 may be changed.

The coreless permanent magnet 123 is positioned on the base 121a and disposed on a surface of the base 121a facing the coreless stator 113, and interacts with the coreless stator 113. That is, the coreless permanent magnet 123 is disposed, as an example, on a lower surface of the base 121a.

Further, the coreless permanent magnet 123 may have the same shape as the coreless stator 113, and as an example, may have a circular shape, but the present invention is not limited thereto.

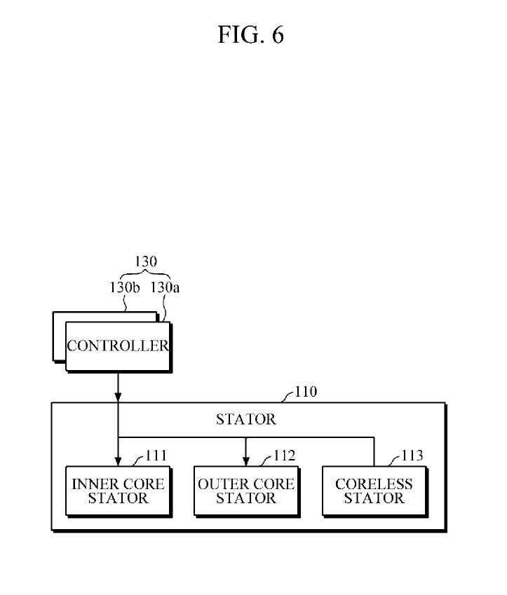

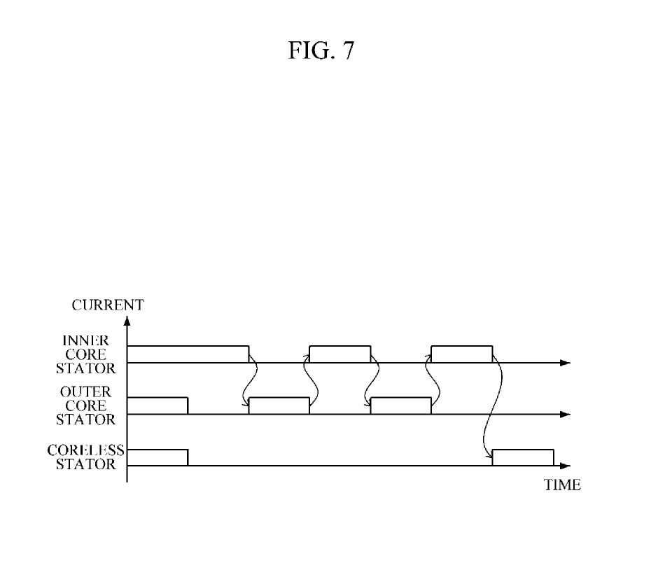

FIG. 6 is a block diagram of the fault-tolerant motor according to one embodiment, and FIG. 7 is a view for describing a control sequence of a controller according to one embodiment. Referring to FIGS. 6 and 7, the controller 130 may be connected to the stator 110 to apply the current sequentially to the stator 110. The controller 130 is connected to the inner core stator 111, the outer core stator 112, and the coreless stator 113 to simultaneously apply the current thereto or apply the current to only one or more ones selected therefrom.

At an initial operation, the controller 130 applies the current to all of the inner core stator 111, the outer core stator 112, and the coreless stator 113 to drive the motor to rotate at high speed within the shortest time, and when a rotation speed becomes constant, and the motor is in a normal track range, the controller 130 may maintain the rotation by applying the current only to one or two selected from the inner core stator 111, the outer core stator 112, and the coreless stator 113. Accordingly, overheating may be prevented by sequentially applying the current to each stator 110.

As an example, at the initial operation, the controller 130 applies the current to all of the inner core stator 111, the outer core stator 112, and the coreless stator 113, and then, cuts off the current applied to the outer core stator 112 and the coreless stator 113 for a certain time when the motor is in the normal track range, and applies the current only to the inner core stator 111, thereby maintaining the rotation of the motor through an interaction between the rotor 120 and the inner core stator 111. When the certain time passes, the controller 130 cuts off the current flowing to the inner core stator 111 and simultaneously applies the current to the outer core stator 112 such that the rotation of the motor may be maintained by the outer core stator 112. When a certain time further passes, the controller 130 may cuts off the current flowing to the outer core stator 112 again, and apply the current to the inner core stator 111 or the coreless stator 113 again.

The above-described example is merely an example showing that the controller 130 may sequentially apply the current to the stator 110, but the present invention is not limited thereto, and the time and order in which the current is applied, the number of the stators 110 to which the current is applied, and the like may be changed.

Further, when an abnormality is detected in any stator 110 to which the current is applied, the controller 130 may immediately cut off the current to the stator 110 in which the abnormality is detected and apply the current to the remaining stator 110, in which the abnormality is not detected, in a pause period. Therefore, even when a problem occurs in the stator 110, the stator 110 may be complementarily operated so that the motor capable of rotating without stopping may be implemented.

The controller 130 may be dual controllers 130a and 130b having a master-slave mode. The controller 130 records and transmits whether an overheating or overcurrent operation and a failure occurred in a driving process by the dual controllers having the master-slave mode, to support driving without stopping and maintenance.

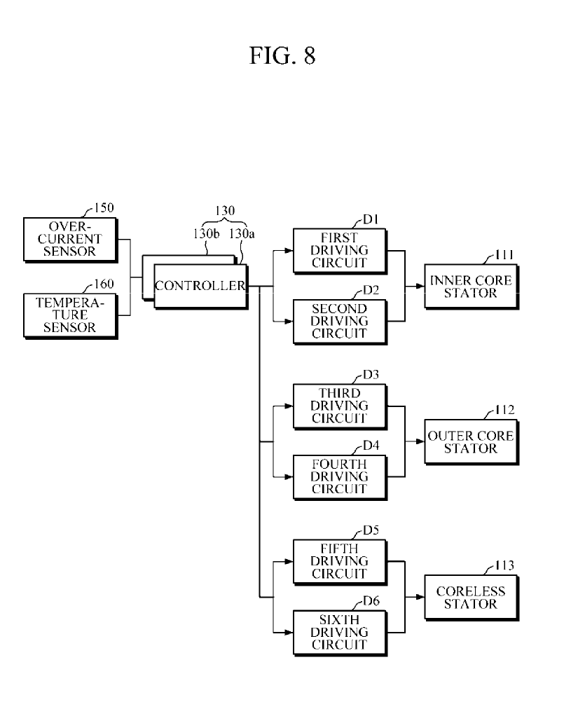

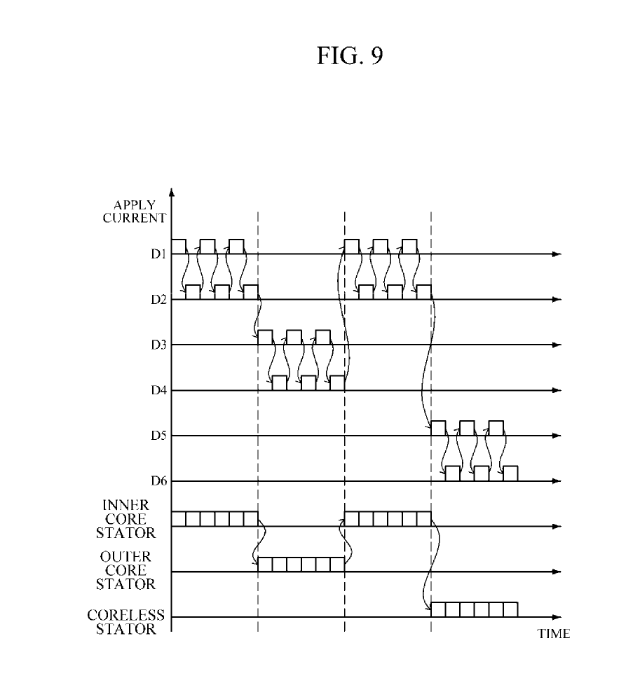

FIG. 8 is a block diagram of a fault-tolerant motor according to another embodiment, and FIG. 9 is a view for describing a control sequence of a controller according to another embodiment. Referring to FIGS. 8 and 9, a plurality of driving circuits 140 may be connected to each stator 110 to apply current to the stator 110. As an example, two driving circuits 140 are connected to each stator 110. The driving circuits 140 may be operated complementary to each other in response to commands from a controller 130. That is, the two driving circuits 140 are operated complementary to each other so that a BLDC motor is prevented from stopping and may be rotated without stopping.

As an example, the controller 130 may apply the current to an inner core stator 111 through a first driving circuit D1 for a certain time and then apply the current to the inner core stator 111 through a second driving circuit D2. The first driving circuit D1 and the second driving circuit D2 may be alternately operated while the current is applied to the inner core stator 111. After applying the current to the inner core stator 111, the controller 130 may control so that the current is applied to an outer core stator 112, and at this time, the outer core stator 112 may be alternately driven by third and fourth driving circuits D3 and D4 as in the first and second driving circuits D1 and D2. After applying the current to the outer core stator 112, the controller 130 may apply the current to a coreless stator 113, and at this time, the coreless stator 113 may be alternately and sequentially driven by fifth and sixth drive circuits D5 and D6.

The above-described example is merely an example showing that the controller 130 may sequentially drive the plurality of driving circuits 140 connected to the stator 110, but the present invention is not limited thereto, and a driving time or order, and the like may be changed

A fault-tolerant motor 100 according to one embodiment of the present invention may further include an overcurrent sensor 150 or a temperature sensor 160. The overcurrent sensor 150 may be connected to the driving circuits 140 to measure whether the current flowing to a module of the driving circuits 140 is not excessive and may deliver a resultant value to the controller 130. That is, the controller 130 measures whether the current is excessive through the overcurrent sensor 150, and may drive or stop the driving circuits 140 according to the resultant value. As an example, when a current value measured by the overcurrent sensor 150 is higher than a preset reference value, the controller 130 may switch the module of the driving circuits 140 to which the excessive current flows to shut off and drive other driving circuits.

Thus, a situation in which semiconductors connected to the driving circuit may be destroyed by the excessive current may be prevented through the overcurrent sensor 150.

The temperature sensor 160 may be connected to the driving circuits 140 to measure a temperature of the module of the driving circuits 140. A measured temperature value is transmitted to the controller 130, and the controller 130 may determine whether to drive the driving circuits 140 on the basis of the transmitted temperature value. When the temperature value measured by the temperature sensor 160 is higher than a preset reference value, the controller 130 may switch the module of the driving circuits 140 having an excessive temperature to shut off and drive other driving circuits.

While exemplary embodiments of the present invention have been described in detail, these embodiments are not intended to limit the scope of the present invention. In addition, various changes and modifications made by those of ordinary skill in the art using the basic concepts of the present invention as defined by the following claims should be construed as being within the scope of the present invention.

1. A fault-tolerant motor comprising:
a stator including an inner core stator and an outer core stator, which are formed in an annular shape and disposed opposite to each other with a gap therebetween, and a coreless stator disposed on at least one selected from the inner core stator and the outer core stator; and
a rotor connected to a rotating shaft and rotated and including a core permanent magnet inserted into the gap and a coreless permanent magnet disposed on a surface facing the coreless stator.

2. The fault-tolerant motor of claim 1, wherein each of the inner core stator and the outer core stator includes an annular body having a coupling groove, a divided core having a protrusion inserted into and coupled to the coupling groove, a bobbin surrounding the divided core, and an electric wire wound around the bobbin.

3. The fault-tolerant motor of claim 1, further comprising a controller connected to the stator, and configured to apply current to all the stators to operate all the stators during an initial or emergency operation, and select and operate sequentially at least one of the inner core stator, the outer core stator, and the coreless stator when torque or a rotation speed of the motor is in a normal track.

4. The fault-tolerant motor of claim 3, wherein the controller measures a temperature of each stator, and when the temperature is equal to or greater than a preset range, the controller cuts off the current flowing to the overheated stator and applies the current to the stator in a pause period to drive the motor without stopping.

5. The fault-tolerant motor of claim 3, wherein when an abnormality occurs in any one of the stators, the controller causes the stator in the pause period to replace a role of the stator in which the abnormality occurs to drive the motor without stopping.

6. The fault-tolerant motor of claim 3, wherein each stator is connected to two or more driving circuits, and the controller sequentially operates each of the two or more driving circuits.

7. The fault-tolerant motor of claim 4, further comprising an overcurrent sensor connected to the driving circuit and configured to measure the current flowing to the driving circuit, or a temperature sensor connected to the driving circuit and configured to measure a temperature of the driving circuit.

8. The fault-tolerant motor of claim 4, wherein the controller is composed of a master-slave dual controller, and the master-slave dual controller records and transmits whether an overheating or overcurrent operation or a failure occurred in a driving process to support driving without stopping and maintenance.
